(19) United States
(12) Patent Application Publication
(10) Pub. No.: US 2015/0104249 A1
(43) Pub. Date: Apr. 16, 2015

(54) DEVICE FOR SECURING A DETACHABLE CYCLE COMPONENT TO A CYCLE, AND USE OF SUCH A DEVICE

(71) Applicant: Pierre BIGARD, MERU (FR)

(72) Inventor: Pierre BIGARD, MERU (FR)

(73) Assignee: LOOK CYCLE INTERNATIONAL, NEVERS (FR)

(21) Appl. No.: 14/507,999

(22) Filed: Oct. 7, 2014

(30) Foreign Application Priority Data
Oct. 10, 2013 (FR) 13 59853

(51) Int. Cl. B62J 1/08; B62K 21/24; B62K 25/02; B62K 21/12

(52) U.S. Cl. CPC B62J 1/08; B62K 21/12; B62K 21/24; B62K 25/02
USPC 403/374.2

(57) ABSTRACT

The device for securing a detachable cycle component, includes clamping elements including at least one clamping member (8) movable between a clamped position for securing the cycle component (1) and an unclamped position for releasing the cycle component, and tensioning elements (11, 12) acting on the clamping member for moving same toward the clamped and unclamped positions. The tensioning elements (11, 12) include a flexible element (11) connected to the clamping member, and a winding member (12) for winding the flexible element (11). This securing device may advantageously be used to secure a cycle component such as a seat post, a wheel or a handlebar to a cycle.

### FIELD OF THE INVENTION

The present invention relates to a securing device intended for securing a detachable cycle component to a cycle.

### BACKGROUND OF THE INVENTION

The cycle component in question is an attached component such as a seat post that can be secured in a seat tube of a cycle frame, a wheel that can be secured to a cycle frame or to a cycle fork, or a handlebar that may be secured to a cycle handlebar stem, itself connected to a steering tube mounted to rotate in a head tube of the cycle frame.

The seat post has the function of connecting a saddle to a cycle frame and comprises, at a top end, a device for securing a saddle to the post and, at a bottom end, a device for securing the post to the frame. The device for securing the saddle to the post is not part of the invention and will not be described in detail.

The device for securing the seat post to the frame comprises clamping means which, when unclamped, allow the seat post to slide inside a seat tube of the frame in order to adjust the height of the seat post.

The clamping means may in the conventional way comprise a split clamping collar secured to the split top end of the seat tube. The ends of the clamping collar have ears which can be brought closer together using a nut and bolt connection in order thus to clamp the top end of the seat tube around the seat post in order to fix the latter at the desired height.

Moreover, the split top end of the seat tube may act as a clamping collar on its own by being provided with two similar securing ears positioned one on each side of the slot in the seat tube.

Other securing devices comprising clamping means associated directly with the seat post to act on the inside of the seat tube are also known. Thus, certain clamping means comprise a tensioning means in the form of a long screw extending down inside the seat post over practically the entire length thereof for collaborating with a clamping member positioned at the bottom end of the seat post.

In an alternative, the clamping member is a chamfered end piece comprising a tapped central hole that accepts the screw. This end piece collaborates with the bottom end of the seat post, which is likewise chamfered, to form a wedge as the screw is tightened to be moved between a clamped position pressing against the interior face of the seat tube and an unclamped position.

In another alternative form, the clamping member is a plate with a tapped central hole positioned at the bottom end of the seat post and collaborating with the screw. The seat post is surrounded by at least one and preferably several rings made of an elastically expandable material which, when they are compressed, grow wider laterally against the interior wall of the seat tube in order to secure the seat post. In order to use a number of rings of this kind, rigid annular spacers are preferably positioned between two successive rings.

In order to obtain effective clamping, it is, however, necessary to use a screw which is not only very long but also of a large diameter. The consequence of this is that the weight of the screw is relatively high, this being a drawback in the overall trend to reduce the weight of cycle components as far as possible, particularly for competition cycles.

A similar arrangement is used for the devices that secure the cycle wheels to a cycle frame or cycle fork. Thus, the wheel is usually clamped to the fork by a spindle passing through the wheel hub. At the threaded ends thereof, this spindle is provided with securing devices comprising clamping means in the form of a nut, or in the form of a cam for rapid clamping.

A securing device is also used for securing other cycle components such as, for example, a handlebar which needs to be secured detachably to the front end of a cycle handlebar stem.

However, the invention is not restricted to the cycle components mentioned hereinabove.

### SUMMARY OF THE INVENTION

It is an object of the invention to propose a securing device for detachably securing a cycle component which overcomes the disadvantages of the known securing devices of this kind while at the same time being highly lightweight, simple, easy to operate and providing reliable clamped securing.

One subject of the invention is a device for securing a detachable cycle component to a cycle, comprising clamping means comprising at least one clamping member movable between a clamped position for securing the cycle component and an unclamped position for releasing the cycle component, and tensioning means comprising a flexible element acting on the said clamping member for moving same toward the said clamped and unclamped positions, characterized in that the said tensioning means further comprise a winding member for winding the flexible element to which member one end of the said flexible element is secured, the said winding member being able to be turned in a first direction to wind a length of the flexible element around the winding member and pull the said clamping member towards the clamped position, and turned in a second direction the opposite of the first direction in order to unwind the said length and cause the said clamping member to move towards the unclamped position.

According to other features of the invention:
the said winding member is incorporated into the said cycle component;
the said winding member is a cylindrical body;
the flexible element extends over a pulley block comprising at least one return member secured to the said at least one clamping member;
the said winding member is associated with a locking device positioned at an end referred to as the outer end of the winding member and allowing the winding member to be locked in the said clamped position;
the said locking device is a ratchet device;
the said ratchet device comprises a notched ring mounted to rotate as one with the winding member and able to engage with a notched recess provided in an end support of the winding member so as to lock the latter in the said clamped position;
the said notched ring is constantly urged axially by an elastic means into engagement with the said notched recess, the said elastic means bearing firstly against a flange of the winding member and secondly against a rear face of the said notched ring;
the said elastic means is a spring;
the said notched ring can be moved axially from its engagement with the said notched recess by a bearing force applied by a user to the front face of the said notched ring so as to compress the said elastic means;
the said outer end of the winding member has a key socket able to accept a key for applying the said bearing force to a transverse element borne by the notched ring; and
the said transverse element is a pin the ends of which are housed in two diametrically opposed accommodating recesses of the notched ring and extending into a longitudinal slot passing radially through the said key socket of the winding member.

Another subject of the invention is a use of the securing device in which the cycle component is any cycle component that needs to be secured detachably to a cycle. Such a cycle component is, for example, a seat post that is to be secured to a seat tube of a cycle frame, or in which the cycle component is a wheel that is to be secured to a cycle frame or to a cycle fork, or alternatively in which the cycle component is a handlebar that is to be secured to a cycle handlebar stem.

### BRIEF DESCRIPTION OF THE DRAWINGS

Other features and advantages of the invention will become apparent from the following description of a number of nonlimiting embodiments of the invention, with reference to the attached figures in which:

FIG. 1 is a perspective view of a seat post provided with the detachable securing device according to the invention;

FIG. 2 is a view in longitudinal section of the seat post of FIG. 1 and of a seat tube illustrating a first embodiment of the invention;

FIG. 3 is a view in longitudinal section of the seat post of FIG. 1 and of a seat tube illustrating an alternative form of the first embodiment of FIG. 2;

FIG. 4 is a view in longitudinal section of the seat post of FIG. 1 and of a seat tube illustrating another alternative form of the first embodiment of FIG. 2;

FIG. 5 is a view in longitudinal section of a seat post and of a seat tube illustrating an alternative form of the first embodiment of the invention;

FIG. 6 is a view in longitudinal section of a seat post and of a seat tube illustrating yet another alternative form of the first embodiment of the invention;

FIG. 7 is an exploded perspective view illustrating a winding member for winding a flexible element and a locking device according to the invention;

FIG. 8 is a perspective view showing the winding member of FIG. 7 separately;

FIG. 9 is a perspective view illustrating the winding member and the locking device of FIG. 6, after assembly;

FIG. 10 is a perspective view showing the external appearance of a locking device according to the invention;

FIG. 11 is an exploded perspective view illustrating a winding member for winding a flexible element and an alternative form of the locking device of FIG. 7;

FIG. 12 is a perspective view illustrating the winding member and the locking device of FIG. 11, after assembly;

FIGS. 13 to 16 are perspective views illustrating a second embodiment of the securing device for a cycle wheel; and

FIG. 17 is a perspective view illustrating a third embodiment of the device for securing a handlebar to the front end of a cycle handlebar stem.

### DETAILED DESCRIPTION OF THE INVENTION

In the figures, elements that are identical or equivalent will bear the same reference signs.

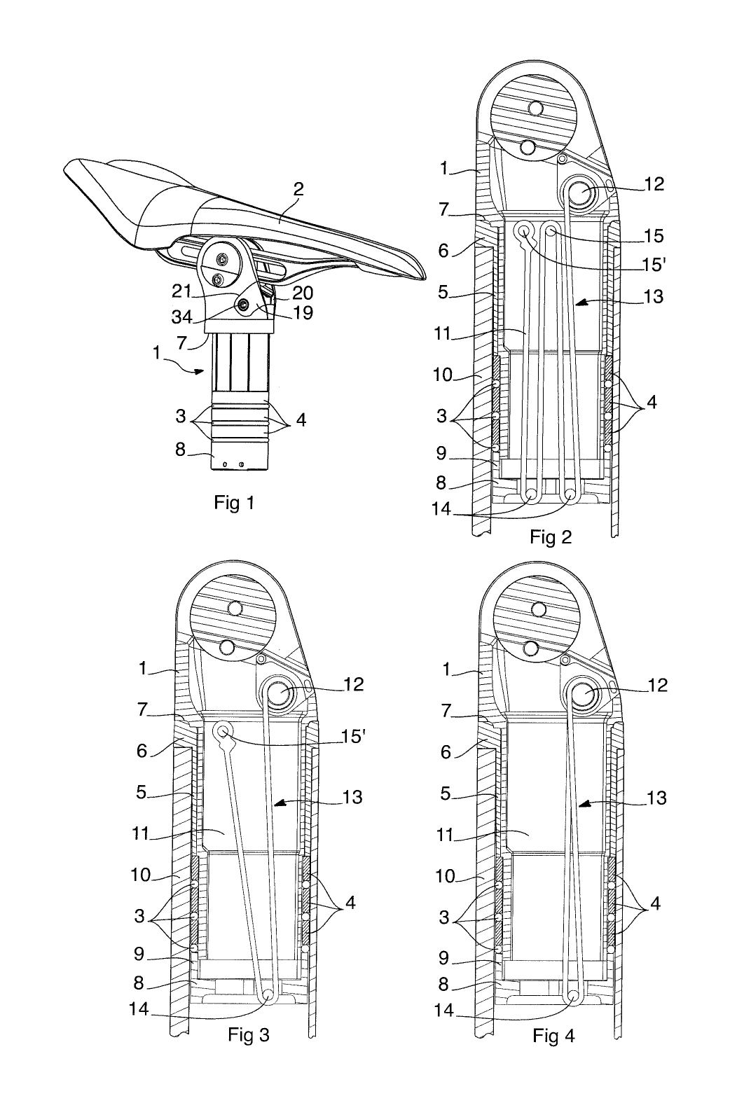

FIGS. 1 and 2 show a seat post 1 provided with a securing device according to the invention. The seat post 1 carries a saddle 2 and, in the example illustrated, several rings 3 made of an expandable material, such as an elastomer, are threaded onto the bottom part of the seat post 1, which has a smaller cross section.

An annular spacer made of a rigid material 4 is positioned between two successive rings 3 and a third spacer is positioned between an upper ring 3 and an end stop on the body of the seat post 1.

Towards the bottom, the seat post 1 ends in a clamping member 8 formed of a plate which on its face that faces towards the rings 3 bears an annular shaping 9 pressing against the bottom ring 3.

The assembly formed by the seat post 1, the rings 3, the spacers 4 and the clamping member 8 is inserted into a seat tube 10 (see FIG. 2) to be secured therein at a height chosen by the cyclist.

To this end, the clamping member 8 can be moved between a clamped position for securing the cycle component which therefore in this instance is the seat post, and an unclamped position for releasing this cycle component.

The clamping member 8 can be moved towards the clamped position by being pulled upwards by means connected to the clamping member, thereby compressing the rings 3 which therefore widen laterally over their entire periphery against the interior wall of the seat tube 10 so as to secure the seat post 1 at the desired height.

According to one important feature of the invention, the tensioning means comprise a flexible element 11 and a winding member 12 which is mounted to rotate with respect to the seat post 1 and onto which the second end of the flexible element 11 can be wound. The winding member 12 may be turned in order to wind a length of the flexible element 11 so as to pull the clamping member 8 upwards, thereby compressing the rings 3.

The flexible element 11 according to the invention may be formed of a cable, a band or a cord made of an inextensible material, such as aramid for example.

The winding member 12 illustrated in this example is a cylindrical body, but can also take the form of a cam (not depicted) so as to achieve clamping and unclamping in a single turn, weaker to start off with and stronger towards the end, with levels following the profile of the cam.

In the embodiment relating to a seat post 1, the winding member 12 is incorporated into this seat post by running transversely in the upper part thereof.

In the embodiment illustrated in FIG. 2, the flexible element 11 extends over a pulley block 13 which, in this example, comprises two return members 14 fixed to the clamping member 8 and one return member 15 fixed into the seat post 1. The flexible element 11 at one of its ends is fixed to a fixing point 15′, likewise provided on the inside of the seat post 1. Thus, the tensioning force and therefore the clamping force are increased.

FIG. 3 shows a simplified alternative form of the pulley block of FIG. 2, with just one return member 14 fixed to the clamping member 8.

FIG. 4 also shows an alternative form of the pulley block of FIG. 2, where likewise just one return member 14 is fixed to the clamping member 8, while the two ends of the flexible element 11 are fixed to the winding member 12, making a loop.

In the absence of such a pulley block, one of the ends of the flexible element 11 can be fixed directly to the clamping member 8 by any appropriate means, for example using a knot, crimping, bonding, splicing.

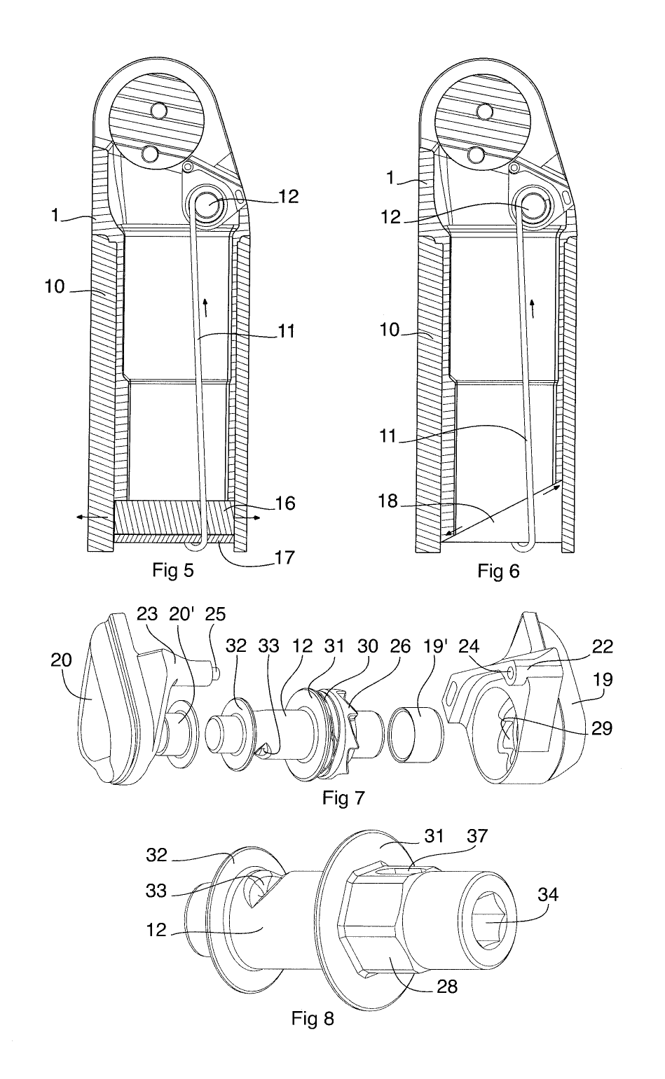

FIG. 5 shows an alternative form of the embodiment described with reference to FIG. 2. In this alternative form, an end piece made of an expandable material 16, similar to the rings 3 of FIG. 2, is positioned at the bottom end thereof, closing off the inside of the seat post at the bottom. As an alternative, this end piece may be annular.

The clamping member is formed by a rigid plate 17 pressing against the outer face of the end piece and to which one of the ends of the flexible element 11 is secured by any appropriate means, for example a knot, crimping, bonding, splicing.

Both the end piece 16 and the plate 17 are suited to the interior shape of the seat tube 10 so that they can be inserted thereinto, along with the seat post 1.

The flexible element 11 can be wound onto the winding member 12 in such a way as to pull the plate 17 upwards to compress the expandable end piece 16 against the annular end face of the seat post. The end piece 16 therefore widens laterally over its entire periphery against the interior wall of the seat tube 10 thereby fixing the seat post 1 thereto.

FIG. 6 shows yet another alternative form of the embodiment described with reference to FIG. 2. In this alternative form, the clamping member is formed by an end piece made of a rigid material 18 positioned at the bottom end of the seat post and having a chamfered face bearing against the end of the seat post, which is likewise chamfered.

One of the ends of the flexible element 11 is fixed to the end piece 18 by any suitable means so as to apply a tensile force thereon when the flexible element 11 is wound onto the winding member 12. The end piece 18 therefore acts as a wedge, sliding against the chamfered end surface of the seat post 1 to wedge the seat post inside the seat tube 10.

The winding member 12 is mounted so that it can rotate between two end supports 19, 20 (see FIGS. 7 and 10 in particular). The end supports 19, 20 are housed in a notch 21 provided at the top end of the seat post 1 (see FIG. 1). The end supports 19, 20 are connected to one another by respective L-shaped eccentric protrusions 22, 23 which respectively bear a female member 24 and a male member 25 collaborating one with the other in order to assemble the end supports (see FIG. 10).

The end supports 19, 20 act as bearers for a respective bearing 19′, 20′ slipped over a respective end of the winding member 12 (see FIG. 7).

FIGS. 7 to 10 furthermore show a locking device that allows the winding member 12 to be locked when the clamping member 8 is in a clamped position and the flexible element 11 is therefore taut.

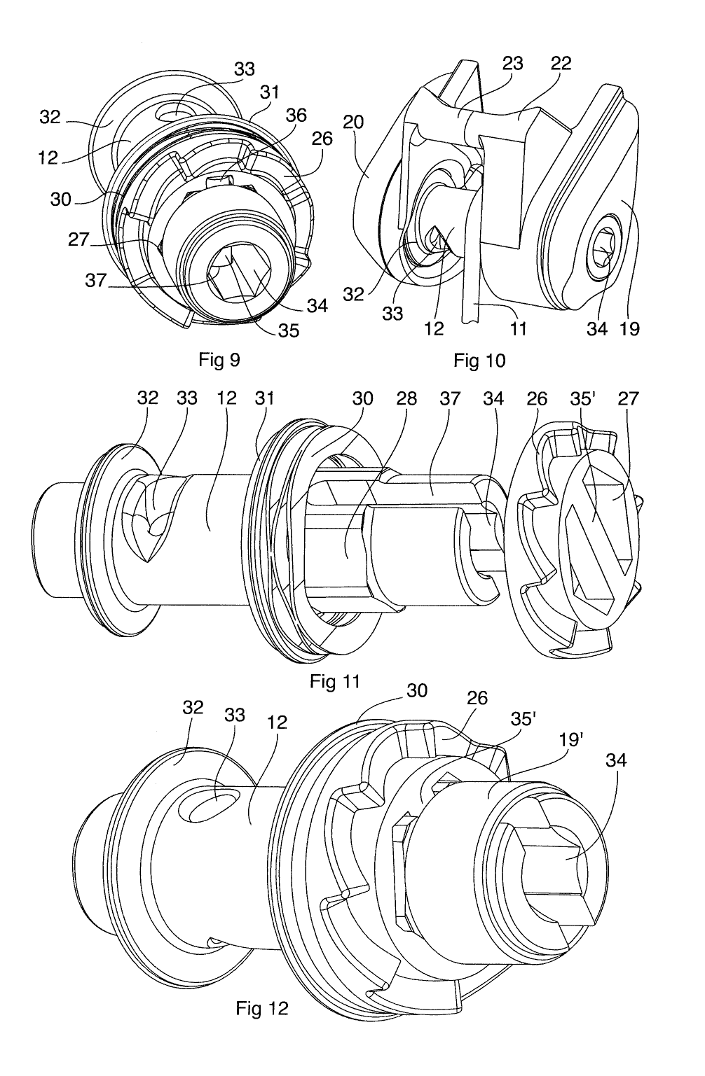

In the example illustrated in FIGS. 7 to 10, the locking device is a ratchet device comprising a notched ring 26 (see FIGS. 7 and 9) that rotates as one with the winding member 12 because of complementing shapes. To this end, the notched ring 26 in the example illustrated has a hexagonal central hole 27 collaborating with a hexagonal shaping 28 provided on the winding member 12.

The notched ring 26 is constantly urged outwards by an elastic means to make it engage with a notched coaxial recess 29 (see FIG. 7) and thus lock the rotation of the winding member 12 with respect to the end pieces 19, 20.

In the example illustrated, this elastic means comprises a crinkle washer 30 bearing on one side against the notched ring 26 and on the other side against one (31) of the two flanges 31, 32 that delimit a winding zone on the winding member 12. This winding zone has a through-hole 33 via which to secure the flexible element 11.

The winding member 12 at its end directed towards the notched recess 29 is provided with a key socket in the form of a central hole 34 forming a key socket which, in the example illustrated, is defined as being a hexagon socket hole (see FIGS. 7 and 9) forming a key socket able to accept a key of complementary shape (not depicted). Thus, by turning the winding member 12 in the clockwise direction, in this instance, the spring 30 is temporarily compressed by the notches sliding over one another to allow a rotation from one notch to the next in the notched recess 29 in order thus to tension the flexible element 11 so as to move the clamping member 8 into its clamped position.

In order subsequently to unwind the flexible element 11 from the winding member 12 by turning the latter in the opposite direction, the spring 30 needs to be kept compressed so that the notched ring 26 can entirely break its engagement with the notched recess 29 for long enough to rotate in the opposite direction.

To this end, the spring 30 may be kept compressed using a key or similar tool introduced into the key socket 34 for applying a bearing force to a transverse element 35 borne by the notched ring.

According to one embodiment of the locking device, the transverse element 35 comprises a pin 35 (see FIG. 9) the ends of which are housed in two diametrically opposed accommodating recesses 36 on the outer face of the notched ring 26 and just one of which is shown in FIG. 9. The pin 35 extends across a slot 37 extending diametrically in the winding member 12, passing through the hexagon hole 34 so as to be accessible to the hexagon operating key (not depicted) that needs to be introduced into that hole for adjusting the clamping.

Thus, when the operating key is inserted into the hexagon hole 34 of the winding member 12, it comes into contact with the pin 35 and can then cause the winding member to turn for clamping. For unclamping, all that is required is for the key to apply a force to the pin 35 to move it along the slot 37, pushing back the notched ring 26 so as to compress the spring 30 and for the spring to be kept compressed while turning the winding member in the opposite direction.

FIGS. 11 and 12 show an alternative form of the locking device in which the transverse element 35 takes the form of a rod 35′ made as one piece with the notched ring 26. The rod 35′ extends diametrically in the central hole 27 of the notched ring 26.

In order to allow the notched ring 26 to be slipped over the winding member 12, the diametral slot 37 in this alternative form is extended as far as the corresponding end of the winding member 12.

The rod 35′ is used in exactly the same way as the pin 35, but because the rod is made as one with the notched ring it acts directly thereon, being pushed back along the slot 37 by a tool introduced into the socket 27 to unlock the locking device.

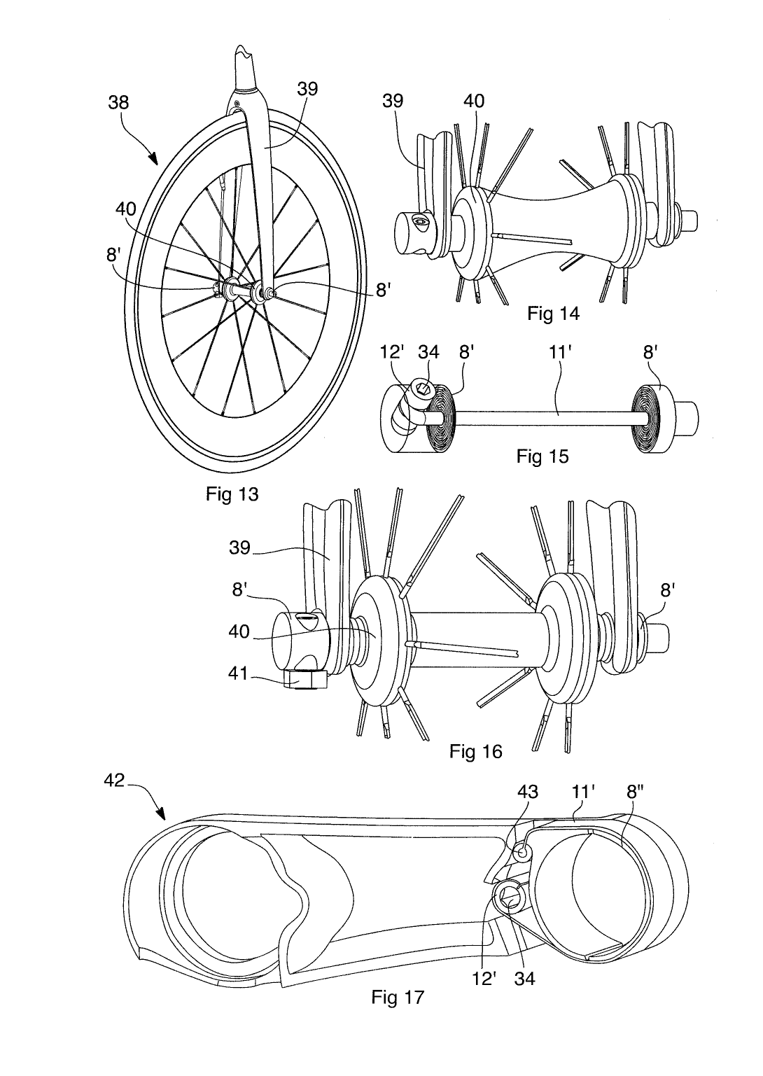

FIGS. 13 to 16 illustrate another use of the detachable securing means according to the invention for securing a cycle wheel 38, in this instance a front wheel, to a cycle fork 39. The securing device may of course also be used in the same way for securing a rear wheel.

In this use of the securing device according to the invention, the conventional clamping means comprising a spindle extending through the hub of the cycle and bearing securing means at each end have been replaced by a flexible element 11′ passing through the cycle hub and a first of the ends of which is connected to a clamping member 8′ and the second end of which is fixed to a winding member 12′ comprising a cylindrical body mounted such that it can rotate in a second clamping member 8′ of the same kind.

The clamping members 8′ are arranged on the outside of one of the respective branches of the fork 39. The winding member 12′ for winding the flexible element 11′ is positioned inside the body of one of the clamping members 8′.

To lock the winding member 12′ in a desired position in order to secure the wheel 38 by clamping, use may be made of a simplified locking device, such as one for example that uses a bolt and nut 41.

FIG. 17 illustrates another use of the securing device of the invention for detachably securing a handlebar (not depicted) to one of the ends of a cycle handlebar stem 42. FIG. 17 shows a perspective and longitudinal section view of a handlebar stem which at its front end bears means for the securing of the handlebar. These securing means comprise a flexible element 11″ in the form of a band one of the ends of which is fixed to the handlebar stem by securing means 43 comprising a small cylinder held inside the handlebar stem, and the other end of which is fixed to a cylindrical winding member 12″ extending in the transverse direction of the handlebar stem body and which according to the invention is mounted so as to rotate therein so that it can also act as a clamping member.

To immobilize the winding member 12″ in a desired position in order to secure a handlebar by clamping, it is possible likewise in this case to use a simplified locking device, such as one that uses a nut and a bolt for example.

Of course, the invention is not restricted to the examples illustrated and described but can be used for securing other cycle components.

1. Device for securing a detachable cycle component to a cycle, comprising clamping means comprising at least one clamping member (8; 8′; 8″) movable between a clamped position for securing the cycle component (1; 38) and an unclamped position for releasing the cycle component, and tensioning means (11, 12; 11′, 12′; 11″, 12″) comprising a flexible element (11; 11′; 11″) acting on the said clamping member (8; 8′; 8″) for moving same toward the said clamped and unclamped positions, characterized in that the said tensioning means (11, 12; 11′, 12′; 11″, 12″) further comprise a winding member (12; 12′; 12″) for winding the flexible element (11; 11′; 11″) to which member one end of the said flexible element (11; 11′; 11″) is secured, the said winding member (12; 12′; 12″) being able to be turned in a first direction to wind a length of the flexible element (11; 11′; 11″) around the winding member (12; 12′; 12″) and pull the said clamping member (8; 8′; 8″) towards the clamped position, and turned in a second direction the opposite of the first direction in order to unwind the said length and cause the said clamping member (8; 8′; 8″) to move towards the unclamped position.

2. Securing device according to claim 1, characterized in that the said winding member (12; 12′; 12″) is incorporated into the said cycle component (1).

3. Securing device according to claim 1, characterized in that the said winding member (12; 12′; 12″) is a cylindrical body.

4. Securing device according to claim 1, characterized in that the flexible element (11) extends over a pulley block (13) comprising at least one return member (14) secured to the said at least one clamping member (8).

5. Securing device according to claim 1, characterized in that the said winding member (12) is associated with a locking device positioned at an end referred to as the outer end of the winding member and allowing the winding member (12) to be locked in the said clamped position.

6. Securing device according to claim 5, characterized in that the said locking device is a ratchet device.

7. Securing device according to claim 6, characterized in that the said ratchet device comprises a notched ring (26) mounted to rotate as one with the winding member (12) and able to engage with a notched recess (29) provided in an end support (19) of the winding member (12) so as to lock the latter in the said clamped position.

8. Securing device according to claim 7, characterized in that the said notched ring (26) is constantly urged axially by an elastic means (30) into engagement with the said notched recess (29), the said elastic means (30) bearing firstly against a flange (31) of the winding member (12) and secondly against a rear face of the said notched ring (26).

9. Securing device according to claim 8, characterized in that the said elastic means (30) is a spring.

10. Securing device according to claim 8, characterized in that the said notched ring (26) can be moved axially from its engagement with the said notched recess (29) by a bearing force applied by a user to the front face of the said notched ring (26) so as to compress the said elastic means (30).

11. Securing device according to claim 10, characterized in that the said outer end of the winding member (12) has a key socket (34) able to accept a key for applying the said bearing force to a transverse element (35) borne by the notched ring (26).

12. Securing device according to claim 11, characterized in that the said transverse element is a pin (35) the ends of which are housed in two diametrically opposed accommodating recesses (36) of the notched ring (26) and extending into a longitudinal slot (37) passing radially through the said key socket (34) of the winding member (12).

13. Method of detachably securing a seat post to a seat tube (10) of a cycle frame, which comprises: providing a securing device according to claim 1; and using the securing device to secure the seat post to the seat tube.

14. Method of detachably securing a cycle wheel (38) to a cycle frame or to a cycle fork (39), which comprises: providing a securing device according to claim 1; and using the securing device to secure the cycle wheel to the cycle frame or fork.

15. Method of detachably securing a handlebar to a cycle handlebar stem (42), which comprises: providing a securing device according to claim 1; and using the securing device to secure the handlebar to the cycle handlebar stem.

16. (canceled)

17. Securing device according to claim 2 characterized in that the said winding member (12; 12′; 12″) is a cylindrical body.

18. Securing device according to claim 9, characterized in that the said notched ring (26) can be moved axially from its engagement with the said notched recess (29) by a bearing force applied by a user to the front face of the said notched ring (26) so as to compress the said elastic means (30).
